(19) United States
(12) Patent Application Publication
(10) Pub. No.: US 2008/0168769 A1
(43) Pub. Date: Jul. 17, 2008

(54) FLUID TUBE ASSEMBLY GUIDE

(75) Inventors: Erich R. Preimesberger, Bolingbrook, IL (US); John C. McCuistion, Chicago, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 11/624,062

(22) Filed: Jan. 17, 2007

(51) Int. Cl. F02B 33/44; F16L 55/00

(52) U.S. Cl. 60/598; 285/27

(57) ABSTRACT

An assembly guide (200) for a fluid connection includes a collar flange (202) connected to an outer surface of a tube (216). The tube (216) may have a first end connected to a first component (306), and a second end that is chamfered (218) and protrudes from the component (306). A neck portion (204) of the guide may be connected to the collar flange (202), and extend away from the collar flange (202). A guide portion (206) of the guide (200) may be connected to the neck portion (204), and may have a flared portion (208) on a distal end that is opposite the neck portion (204).

### FIELD OF THE INVENTION

This invention relates to internal combustion engines, including but not limited to fluid tubes for an internal combustion engine.

### BACKGROUND OF THE INVENTION

Internal combustion engines have fluid systems associated therewith that transfer many different kinds of fluids between different engine locations and components. A typical engine is a complicated engineered product, which may include 5,000 or more different components. Engines are also products that are produced in great quantities, so their assembly process and quality thereof is an important factor for any engine manufacturer.

Many different types of fluid connections may exist between engine components. These fluid connections may be arranged to transfer different types of fluids at different pressures, temperatures, and flow rates. One example of a component requiring fluid connections is a turbocharger. Turbochargers are used to extract energy from exhaust gas created during operation of the engine, and use the energy extracted to operate a compressor that compresses intake air of the engine. Turbochargers are typically lubricated with a flow of engine oil that passes through the turbocharger center housing.

A supply flow of oil to a turbocharger may be cooled, and may be supplied from an oil pump on the engine. After the flow has passed though the turbocharger, it may return to the engine through, primarily, the force of gravity. This means that a fluid drain connection between the turbocharger and the engine has to be at a low point, typically beneath the turbocharger. Such a connection, which lies beneath a component, is typically referred to as a “blind” connection because an assembly operator is not able to visually inspect the connection while installing the component that lies above it, in this case, the turbocharger.

There have been many attempts to improve the robustness of blind fluid connections during assembly of an engine. Many attempt to reduce positional variability in the positioning of the turbocharger on the engine in order to improve alignment of mating fluid connection components. Others, have moved the connecting fluid point between the components in a more visible location. All these methods may increase cost and complexity of the assembly process, and are partially effective in ensuring that a robust connection has been made.

Accordingly, there is a need for an improved blind fluid passage connection configuration for transferring fluid in an engine that is not complicated and time consuming to implement.

### SUMMARY OF THE INVENTION

An assembly guide for a fluid connection includes a collar flange connected to an outer surface of a tube. The tube may have a first end connected to a first component, and a second end that is chamfered and protrudes from the component. A neck portion of the guide may be connected to the collar flange, and extend away from the collar flange. A guide portion of the guide may be connected to the neck portion, and may have a flared portion on a distal end that is opposite the neck portion.

### BRIEF DESCRIPTION OF THE DRAWINGS

FIG. 1 cross-section view of a known fluid connection configuration for a tube.

FIG. 2 is a cross-section view of an assembly guide connected to a tube in accordance with the invention.

FIG. 3 is a cross-section view of a fluid connection configuration for a tube having an assembly guide, shown in a disassembled position, in accordance with the invention.

FIG. 4 is a cross-section view of a fluid connection configuration for a tube having an assembly guide, shown in an as-installed position, in accordance with the invention.

FIG. 5 is a flowchart for a method of accomplishing a blind fluid connection between a component having a drain tube and a receiving part having a bore, in accordance with the invention.

### DESCRIPTION OF A PREFERRED EMBODIMENT

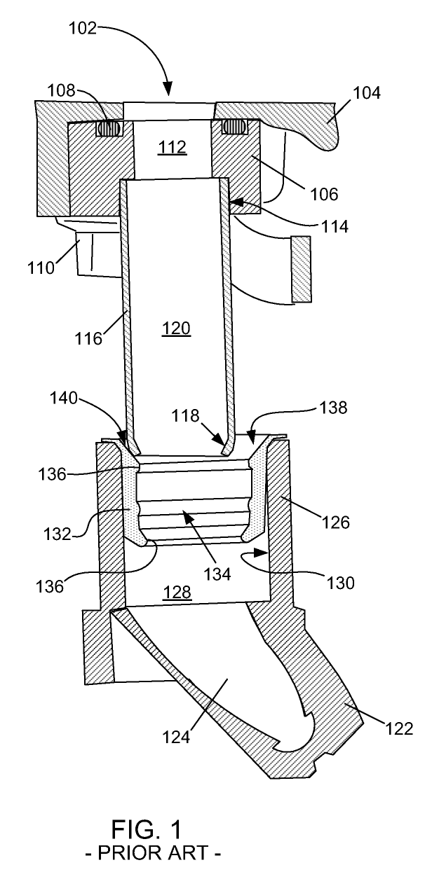

The following describes an apparatus for and method of ensuring a proper fluid connection on a “blind” assembly of a fluid passage for an internal combustion engine. A blind assembly may be a step in an assembly process of an engine, during which an operator conducting the assembly step is not able to visually align and/or inspect a fluid connection. A detail cross-section view of a typical fluid connection configuration is shown for illustration in FIG. 1. The fluid connection shown in FIG. 1 is for a drain passage 102 for oil from a center housing 104 of a turbocharger. A flange 106 having a seal 108 disposed in contact with the center housing 104 may be connected to the center housing 104 and secured thereto with one or more bolt fastener(s) 110. The flange 106 may have an opening 112 in fluid communication with the passage 102 in the center housing 104, and a bore 114 arranged to receive a tube 116 that is connected thereto, for example, with a press-fit connection. The tube 116 may be a thin walled steel tube having a first end press-fitted into the bore 114 of the flange 106, and a second end having a rounded edge 118. A tube passage 120 fluidly connects the first and second ends of the tube 116, and fluidly communicates with the opening 112 of the flange 106.

The flow of oil draining from the center housing 104 during operation may be arranged to drain into a receiving part 122, typically a crankcase. The receiving part 122 has a fluid passage 124 formed therein for transporting the flow of oil from the center housing 104 into the receiving part 122. The receiving part 122 may have a receiving bore feature 126 formed at a distal end that is arranged to receive the tube 116 during assembly. The receiving bore 126 may form an internal cavity 128 having an inside surface 130. The internal cavity 128 may include a collar seal 132 disposed therein that is arranged to create a fluid seal between the tube 116 and the inside surface 130 when the tube 116 is inserted into the receiving bore feature 126.

The seal 132 may include a central opening 134 arranged to receive the tube 116. A plurality of ribs or sealing rings 136 may be formed in the seal 132 at different locations surrounding the central opening 134 for sealably engaging an outer surface of the tube 116 under unitary load conditions that achieve the desired sealing function. The seal 132 may also have a tapered inlet portion 138 for receiving and guiding the tube 116 into the central opening 134 during insertion.

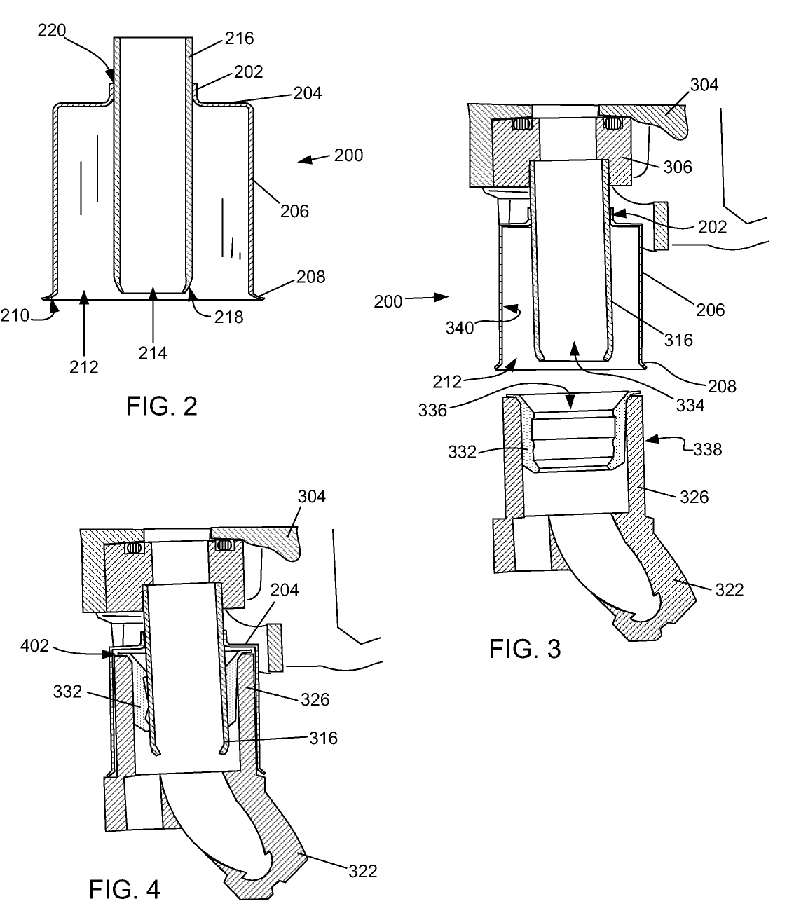

In the condition shown in FIG. 1, and as occurs often during engine assembly operations, the tube 116 is misaligned with respect to the receiving bore 126. Under such a condition, the rounded edge 118 of the tube 116 may be too far out of alignment with respect to the tapered inlet portion 138 of the seal 132. In this case, a “pinch” point 140 may be created for the seal 132 between the tube 116 and the inside surface 130. This pinch point 140 condition may not be visible to the operator performing the assembly operation, and may pass unnoticed after assembly is complete. However, the pinch point 140 may compromise or even damage the seal 132 and potentially causing a fluid leak during service. The pinch point 140 in a blind fluid connection that may damage the seal 132 during assembly may advantageously be avoided by use of an assembly guide 200, shown in cross section in FIG. 2.

The assembly guide 200 may be arranged to connect to a tube 216. The tube 216 may be similar to the tube 116 described above, having a first end arranged for press-press fitting or otherwise connecting to a component, and a rounded edge 218 at a second end. The assembly guide 200 may have a collar flange 202 formed at one end, a neck portion 204 connected to the collar flange 202, a guide portion 206 connected to the neck portion 204, and a flared portion 208 connected to the guide portion 206.

The collar flange 202 may be welded, brazed, swaged, or otherwise connected to the tube 216 along an interface 220. The interface 220 may advantageously be positioned closer to the first end of the tube 216 than the second end having the rounded edge 218. The guide portion 206 may be substantially cylindrical and surround the tube 216 concentrically along it's length. The flared portion 208 may flare away from the tube 216, and terminate at an edge 210 that is located beyond the rounded edge 218 of the tube 216. The assembly guide 200, as installed onto the tube 216, may define a guide opening 212 that surrounds a tube opening 214 concentrically around the rounded edge 218. The neck portion 204 may connect the guide portion 206 with the collar flange 202 and create a closed-end or a stop across from the guide opening 212.

A cross-section view of the assembly guide 200 disposed on a center-housing 304 in an un-assembled state is shown in FIG. 3. The assembly guide 200 is connected to a tube 316, and the tube 316 is connected to a flange 306, which in turn is connected to the compressor 304 as described above. The collar flange 202 is advantageously disposed below the flange 306. A receiving component 322 has a receiving bore 332 disposed therein. For successful assembly of the compressor 304, an “outlet” opening 334 of the tube 316 should align with an “inlet” opening 336 in the seal 332.

During installation of the center-housing 304, the receiving bore 326 of the component 322 advantageously enters the guide opening 212. An outer diameter 338 of the receiving bore 326 fits with and aligns to an inner surface 340 of the guide portion 206 of the assembly guide 200. Thusly, the tube 316 may advantageously remain centered and aligned with the receiving portion 326 and the seal 332, the outlet opening 334 of the tube 316 aligned with the inlet opening 336 of the seal 332, and there are advantageously no misalignment issues that may cause pinch points in the seal 332.

A cross-section view of the assembly guide in an as-installed position between the center-housing 304 and the component 322 is shown in FIG. 4. When insertion of the tube 316 in the seal 332 is complete, the assembly guide 200 may remain around the receiving portion 326 to advantageously provide additional protection from water intrusion, and heat shielding, to the seal 332. The assembly guide 200 may advantageously not interfere with the insertion depth of the tube 316 into the seal 332, and a gap 402 may be designed-in that remains between the neck portion 204 of the assembly guide 200 and the receiving portion 326 of the component 322.

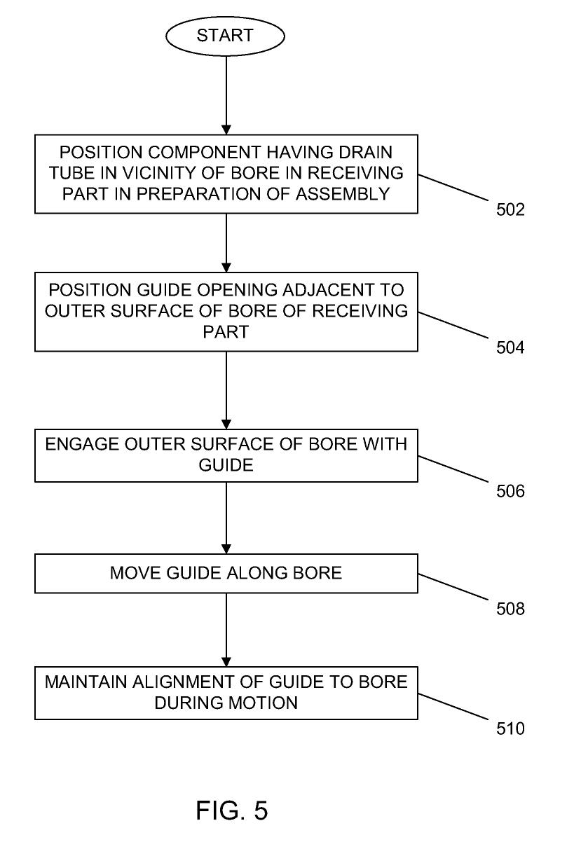

A flowchart for a method of accomplishing a blind fluid connection between a component having a drain tube and a receiving part having a bore is shown in FIG. 5. A component having the drain tube attached thereon may be positioned in the vicinity of the bore in the receiving part in preparation of assembly at step 502. The tube may have an assembly guide thereon that defines a guide opening between the assembly guide and the tube. The guide opening may be positioned adjacent to an outer surface of the bore at step 504. The guide opening may be made to engage the outer surface of the bore at step 506. An edge of the guide opening may advantageously be flared out and away from the tube to facilitate entry of the bore into the guide opening. The component may be moved along the guide opening onto the receiving component at step 508. During the motion of the component, the guide opening may advantageously maintain alignment of the tube in the bore at step 510. A seal may be used to sealably engage both the tube and an inner surface of the bore. Moreover, the assembly guide may shield the seal from debris and heat during service.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An assembly guide for a fluid connection, comprising:
a collar flange connected to an outer surface of a tube, wherein the tube has a first end connected to a first component, and wherein the tube has a second end that is chamfered;
a neck portion connected to the collar flange, wherein the neck portion extends away from the collar flange;
a guide portion connected to the neck portion, wherein the guide portion has a flared portion on a distal end that is opposite the neck portion.

2. The assembly guide of claim 1, wherein the collar flange is disposed closer to the first end of the tube that the second end.

3. The assembly guide of claim 1, wherein the guide portion has a substantially cylindrical shape and is disposed concentrically around the tube.

4. The assembly guide of claim 1, wherein the flared portion extends away from the tube and terminates at an edge.

5. The assembly guide of claim 4, wherein the edge extends past the second end of the tube.

6. The assembly guide of claim 1, wherein a guide opening is defined between the guide portion of the assembly guide and the outer surface of the tube.

7. A turbocharger for an internal combustion engine, comprising:
a center housing having a fluid drain opening;
a flange connected to the center housing, wherein the flange has a tube opening in fluid communication with the fluid drain opening;
a tube connected to the flange, wherein the tube has a drain passage in fluid communication with the tube opening, wherein the tube is connected to the flange at a first end, and wherein the tube has a second end that is rounded;
an assembly guide disposed on the tube, the assembly guide comprising:
a collar flange connected to the tube along an interface;
a neck portion connected to the collar flange; and
a guide portion connected to the neck portion;
wherein the assembly guide is arranged to engage an outer surface of a bore that is formed in a receiving part, the receiving part having a fluid passage formed therein that is disposed in fluid communication with the drain passage in the tube when the turbocharger is connected to the receiving part.

8. The turbocharger of claim 7, wherein a seal having an inlet opening is disposed on an inner surface of the bore in the receiving part, and wherein the seal sealably engages the inner surface of the bore and the tube when the tube is disposed in the bore of the receiving part.

9. The turbocharger of claim 7, wherein the guide is arranged to concentrically align the tube with the bore of the receiving part during an insertion operation of the tube into the bore.

10. The turbocharger of claim 7, wherein the guide portion has a substantially cylindrical shape, wherein the guide portion is disposed concentrically around and along the tube, and wherein a guide opening is defined between the guide portion and the tube.

11. The turbocharger of claim 10, wherein the neck portion defines a stop on one end of the guide opening.

12. A method of accomplishing a blind fluid connection between a component having a drain tube and a receiving part having a bore, comprising the steps of:
positioning the component close to the bore of the receiving part;
locating a guide opening adjacent to an outer surface of the bore of the receiving part;
engaging the guide onto the outer surface of the bore;
moving the component into an as-installed position by moving the guide along the outer surface of the bore;
maintaining an alignment of the guide to the bore during motion.

13. The method of claim 12, further comprising the step of connecting the guide to the drain tube.

14. The method of claim 12, further comprising the step of inserting the drain tube into a seal disposed in the bore.

15. The method of claim 12, further comprising the step of sealably engaging the drain tube with a seal disposed in the bore.

16. The method of claim 12, further comprising the step of shielding a seal disposed in the bore with the guide.

17. The method of claim 12, further comprising the step of facilitating entry of the guide over the outer surface of a bore by having a flared-out edge formed on the guide.
